(19) United States
(12) Patent Application Publication
(10) Pub. No.: US 2006/0140063 A1
(43) Pub. Date: Jun. 29, 2006

(54) Method for optimizing mode sequencing in a multimode electronic device

(76) Inventors: Louis M. Galie, Newtown, CT (US); Ronald S. Lizzi, Bethany, CT (US)

Correspondence Address: Arthur G. Schaier;Carmody & Torrance LLP, 50 Leavenworth Street, P.O. Box 1110, Waterbury, CT, 06721-1110, US

(21) Appl. No.: 10/936,628

(22) Filed: Sep. 8, 2004

(51) Int. Cl. G04C 17/00; G04C 9/00; G04C 21/00

(52) U.S. Cl. 368/187; 368/69

(57) ABSTRACT

A method of displaying a plurality of modes in a multimode electronic device. In a preferred embodiment, the method comprises the steps of determining a number of usage events over a predetermined time period for each of at least two reorderable modes, and in a mode selecting mode, displaying the reorderable modes in a sequence that is based on the number of usage events determined in each of the at least two reorderable modes. In another embodiment, the method of displaying the plurality of reorderable modes comprises the steps of determining an amount of time usage over a predetermined time period for each of the at least two reorderable modes, and in the mode selecting mode displaying the reorderable modes in a sequence that is based on the amount of time usage determined in each of the at least two reorderable modes. An electronic device that provides for the reorderability of at least two reorderable modes among a plurality of modes is also provided.

### BACKGROUND OF THE INVENTION

The present invention relates generally to user interface methodologies for electronic devices, such as, but not limited to timepieces such as watches, and in particular, to an improved methodology for an electronic device that optimizes mode sequencing in a set of a plurality of modes, thus being able to more particularly and desirably customize the use and functionality of the electronic device.

Watches having a plurality of modes are well known and described in a multitude of issued patents, such as, but not limited to, U.S. Pat. Nos. 4,783,773; 4,780,864; 5,555,226; and 4,283,784. The disclosures of such patents are incorporated by reference as if fully set forth herein.

There continues to be a push towards incorporating more and more functionality into such electronic devices, such as providing more and more modes that a user may find useful and/or desirable. Aside from the common modes found in such electronic devices (e.g. time-of-day (TOD) mode, date (DATE) mode, chronograph (CHRONO) mode, alarm (ALARM) modes, countdown (TIMER) modes, and even alternate time zone (T2) modes), such devices are becoming more versatile. For example, heartrate monitors are being incorporated into wristwatches and therefore, additional modes such as heartrate (HR) modes where one can monitor his/her own heartrate during a workout are being provided. Still further, by developing a communication link with a GPS, the speed (SPEED) and distance (DIST) traveled of the user can be monitored in a SPEED mode and/or a DIST mode, for example, and can be displayed and recalled later during workout summaries. The technology to provide such functionality is well known and not relevant to the present invention.

To still better appreciate the scope and potential of the present invention, it should also be recognized that the foregoing is but just a few examples of functionality being provided in such electronic devices. Other available features put in such devices are described in U.S. Pat. No. 5,737,246 (electronic wristwatch with water depth measuring capability); U.S. Pat. No. 6,314,058 (describing a “health watch” for digitally displaying a plurality of information, such as time, atmospheric temperature, body temperature, heart rate and blood pressure); U.S. Pat. No. 4,407,295 (describing a miniature portable physiological parameter measuring system with interchangeable sensors); and U.S. Pat. No. 6,356,856 (describing a system for measuring the speed of a person while running or walking along a surface), are only but a few examples. As therefore can be seen, the prior art generally recognizes that a timepiece, such as a wristwatch, can be provided with a plurality of modes, although not all of which need be (or usually can be) utilized or employed simultaneously.

All of these modes may be accessed in a number of ways, such as through the sequencing thereof using manually actuatable side and/or top pushers, and even more recently by the use of a rotating stem and/or top ring, as more particularly set forth in commonly owned U.S. Pat. Nos. 6,146,010 and 6,203,190 as well as WO 0107971 entitled “Setting Functions For A Multimode Timepiece” by G. Stotz, et al., the disclosures of which are all incorporated by reference as if fully set forth herein.

As would be expected, watch designers and programmers are continuously striving for, constructing and/or designing such electronic devices, such as watches, to be more “user friendly” by providing a user with more available modes while at the same time attempting to permit the user to cycle through such modes more easily and conveniently.

A perceived deficiency in the prior art is not in the providing of users with more and more options (i.e. functionality and/or modes), but rather is in the potential information overload and frustration caused by such voluminous information availability. That is, what modes may be desirable for one user may be useless (or less than desirable or needed) for another user. Still further, modes not being immediately utilized could advantageously be (at least temporarily) hidden from view. For example, a user not soon to be going under water may not need (or desire) to be required to scroll through the mode that displays water depth, as suggested above. Similarly, a user that does not use a heartrate monitor (e.g. a chest strap) need not have (or want) to scroll through the HR mode, since it would be intuitively clear that there is no current workout in progress. As but another example, a user may not want to scroll through the SPEED and/or DIST mode when he/she hasn't used the mode in the last month, since it could be assumed that the displayable data would either be “zero” or stale (i.e. old).

U.S. Pat. No. 6,669,361 the disclosure of which is incorporated by reference as if fully set forth herein, discloses and claims significant advances in the art in the foregoing regard by providing methodologies and constructions for being able to manually disable and enable modes in such an electronic device. In a similar manner, U.S. application Ser. No. 10/744,885, the disclosure of which is also incorporated by reference as if fully set forth therein, also discloses and claims significant advances in the art whereby the method of enabling the displayability of hidden modes is based on a determination of whether data in the mode satisfies a specified condition, such as whether the data is non-zero or has been updated and/or changed in a last predetermined period (e.g. over the last several days) and/or is available for displayability.

However, it is believed that yet further advances in the art are desirable. Specifically, it is desirable to provide methodologies and constructions for reordering the displayability of the modes based on predetermined criterions, such as the amount of use that a particular mode(s) receives, (which can be measured in a variety of ways, examples of which are provided below) so that optimization of the ordering and displayability of the modes, among other things, is achieved, all in furtherance of still further customizing and improving the functionality of the electronic device.

Accordingly, it is desirable to provide an electronic device that can still be further customized and more particularly configured to a user's personal use thereof. The present invention achieves the aforementioned and below mentioned advantages.

### OBJECTS AND SUMMARY OF THE INVENTION

Accordingly, it is an object of the present invention to provide an improved programming and mode display methodology for multimode electronic devices and, in particular, of a wristwatch, that allows an electronic device to be customized to the use of the user.

It is another object and advantage of this invention to provide an improved mode display methodology for such electronic devices that makes the device more “user friendly” and customizable to the user.

It is yet another object and advantage of this invention to provide an improved mode display methodology that makes the device more marketable to a wider range of users.

It is still another object and advantage of this invention to provide an improved mode display methodology that permits manufactures, designers or programmers of such devices to further provide users with demanded functionality, yet provide a construction and methodology to permit the electronic device to configure itself to better meet the users needs, desires and uses therefor.

Another object of the present invention is to provide a device having an improved multi-level user interface.

In particular, it is an object of the present invention to provide an electronic device that provides for improved displayability (e.g. the ability to reorder the display) of modes based on particular usage criteria of the various modes.

Further objects and advantages of this invention will become more apparent from a consideration of the drawings and ensuing description.

The foregoing and other problems are overcome and the objects and advantages are realized by methods and constructions in accordance with embodiments of this invention, wherein improved mode selecting and programming methodologies and a construction thereof for a multimode electronic device are disclosed.

Accordingly, in accordance with the present invention, a method of displaying a plurality of modes in a multimode electronic device of the type having an integrated circuit operable in a plurality of modes, wherein the plurality of modes comprises a mode selecting mode and at least two reorderable modes each of which has associated therewith a mode indicator, wherein in the mode selecting mode, the electronic device cycles among at least the two reorderable modes and displays mode indicators for the respective reorderable modes, such that the display of a mode indicator precedes the selectability of the reorderable mode whose mode indicator is being displayed, wherein the method of displaying the plurality of reorderable modes comprises the steps of: determining a number of usage events over a predetermined time period for each of the at least two reorderable modes; and in the mode selecting mode, displaying the reorderable modes in a sequence that is based on the number of usage events determined in each of the at least two reorderable modes. In but two exemplary embodiments, a usage event may be defined as an entering of the reorderable mode and/or actuation of selected actuation means while in the reorderable mode or an entering of the reorderable mode and remaining in that reorderable mode without exiting that mode for a predetermined minimum amount of time.

In an alternative embodiment, the method of displaying the plurality of reorderable modes comprises the steps of: determining an amount of time usage over a predetermined time period for each of the at least two reorderable modes; and in the mode selecting mode: displaying the reorderable modes in a sequence that is based on the amount of time usage determined in each of the at least two reorderable modes.

An electronic device that provides for the reorderability of at least two reorderable modes among a plurality of modes is also provided.

In each of the preferred embodiments, the electronic device is preferably a timepiece, and a wristwatch in particular.

### BRIEF DESCRIPTION OF THE DRAWINGS

FIG. 1 illustrates a flow diagram of an exemplary methodology in accordance with the present invention, provided to be used in connection with an electronic device, such as, but not limited to, a watch;

FIG. 2 is a simplified set of arrays for a plurality of reorderable modes to best illustrate the present invention; and

FIG. 3 is a simplified circuit schematic, to be incorporated into a device, for carrying out the methodology in accordance with the present invention.

### DETAILED DESCRIPTION OF THE PREFERRED EMBODIMENTS

The present invention is intended to complement and further the state of the art by providing methodologies to optimize the displayable ordering of enabled modes during a mode selecting mode based on, for example, defined usage events or usage time within selected modes.

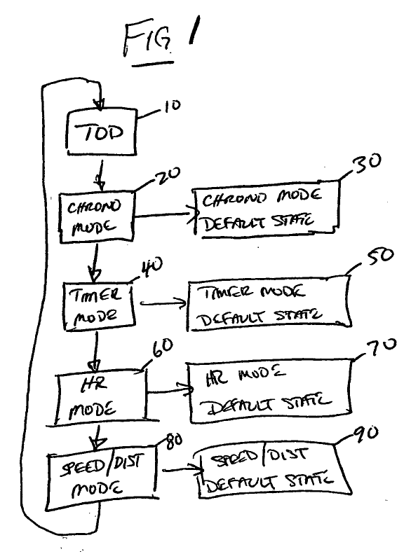

To set forth the preferred methodology of the present invention, reference should be had to FIG. 1, although it should be understood that the following has been simplified to explain the implementation of the present invention. Such simplification should be understood as exemplary and not by way of limitation.

By way of terminology, the “mode selector” may be a dedicated pusher (hereinafter coined the “mode button”) as would be well known in the art, or may be comprised of a rotating switching mechanism that is positionable in at least two axial positions, such as that disclosed in U.S. Pat. No. 6,203,190. An included integrated circuit is operable in at least an active mode state being the mode in which the device may be in (e.g. TOD, DATE, ALARM, SPEED/DIST, HR, etc.) and a mode-selecting mode wherein the device is capable of cycling among and between the plurality of modes. The mode button may permit operatively cycling among the modes and/or the rotating switching mechanism may perform this function when it is a selected one of the axial positions. Selection of a next mode from the plurality of modes may be achieved by rotating the switching mechanism either clockwise or counterclockwise until the next active mode is exhibited, while continued and/or repeated depression of the mode button would achieve the same effect. Furthermore, it may be assumed that each actuation of the mode button, or, if the device incorporates the rotating switching mechanism, each clockwise (CW) or counterclockwise (CCW) rotation of the switching mechanism (while in a selected axial position), selects the next mode from within the “mode list.”

To best illustrate (by example, and not limitation) the advantages of the present invention, reference will first be made to the diagram of FIG. 1. For simplicity, it is assumed that the device incorporating the methodology of FIG. 1 has at least the following modes: TOD (“time of day”; always present), CHRONO, TIMER, HR (heartrate) and SPEED/DIST (for providing information regarding a current workout).

FIG. 1 is provided to convey that in the preferred embodiment of the present invention, an initial ordering of the modes in the mode list, and enterable and/or viewable from the mode selecting mode, is as follows: TOD, CHRONO, TIMER, HR and SPEED/DIST.

In the example provided, all modes other than TOD shall be reorderable. As disclosed below, such reorderable modes may in fact also be “viewinhibitable” (i.e. if particular criterion(s) are not satisfied, the viewing and thus entering of these modes may be less than facilitated (e.g. prevented or hindered)). For example, one who does not regularly use the CHRONO and TIMER modes may wish to avoid (i.e. skip) these modes on a regular basis, and the present invention facilitates this. The next mode accessible in the mode list of FIG. 1 is the heartrate (HR) mode, which may be provided and used to display current heart rate information during exercise. As this is likewise an optional mode, a user may wish to skip this mode if in fact he/she does not (or has not) regularly used this feature. In a similar manner, the current Speed/Distance (current SPEED/DIST) mode, which is provided and used to display current speed and distance of a user when the electronic device is in communication with a GPS, may be skipped if the user was not recently (or is not) in communication with the GPS. As will be seen below, such modes may be ordered so that they are at the bottom of the list of displayed modes, or may be entirely view inhibited.

Turning to the particulars of FIG. 1, in conventional fashion, from the TOD mode (at Block 10) and in the mode selecting mode, depression of the mode button or rotation of the switching mechanism as set forth above causes the device to leave the TOD mode, and, in the present example, display the CHRONO mode banner (Block 20). As is well known in the art, without further actuation of the mode button or without further rotation of the rotating switching mechanism after the exhibiting of the selected mode, the device preferably enters the particular mode (i.e. Block 30). In this way, setting and/or viewing of the data (e.g. chronograph timer in this example) can occur. Preferably, non-rotation of the rotating switching mechanism or non-depression of the mode button for 1.5 seconds will cause the device to enter the selected mode. The utilization of the 1.5-second delay permits a user to identify the particular mode for which entry may be desired, all of which currently exists in watches on the market.

Continuing with the flow diagram of FIG. 1, rotation of the switching mechanism (or depression of the mode button) would cause the methodology to arrive at Block 40, wherein after a 1.5 second delay, the TIMER mode would be entered (Block 50). Continued rotation of the switching mechanism (or depression of the mode button) would cause the methodology to arrive at Block 60, wherein after a 1.5 second delay, the HR mode would be entered (Block 70). For completeness, it can be seen that continued rotation of the switching mechanism (or depression of the mode button) would cause the methodology to arrive at Block 80, wherein after a 1.5 second delay, the SPEED/DIST mode would be entered (Block 90).

Clearly, it is a matter of simple design choice as to where the methodology steps from respective Blocks 30, 50, 70 and 90 after exiting a particular mode. For example, it is within the skill of the designer to have the device return to the “home” (e.g. TOD) mode so as to be able to best appreciate the advantage of the reordering of the mode displayability.

In accordance with the present invention and to best highlight its advantages, the CHRONO, TIMER, HR and SPEED/DIST modes are all reorderable modes, in that their order in the mode-selecting mode as set forth above is changeable. That is, cycling through the modes may be as set forth above (e.g. TOD, CHRONO, TIMER, HR and SPEED/DIST) or they may be reordered (e.g. TOD, HR, CHRONO, SPEED/DIST and TIMER). The following sets forth the particulars of when and how, and on what basis, such modes get reordered.

In the preferred embodiments, the modes are reorderable for display and cycling through based on the number of defined usage events and/or usage time for each mode during a predetermined period of time. That is, in the most general embodiment, the detectable usage event for which incrementing of the counter is most preferable is an entering of the reorderable mode (e.g. proceeding from Block 20→30, Block 40→50, Block 60→70 and/or Block 80→90). However, the invention is in no way limited thereto, as a usage event may be defined by the actual engagement of a selected actuation means (e.g. pusher or rotatable stem) while in the reorderable mode. In another preferred embodiment, a usage event for a mode may comprise the determination that the device has been operated in that particular mode for a minimum amount of time. For example, it is contemplated that the particular array only be incremented after having detected a “usage event” when the integrated circuit was operating in that mode (e.g. without exiting) for at least a predetermined number of seconds (e.g. 10 seconds). In this way, it may be presumed that the user intended to enter that mode (as opposed to a mere delay in actuation of any pusher, etc, which caused the device to enter the mode against the desired intent of the user). This would avoid, for example an inadvertent or unintentional entering of a mode from being deemed a usage event, as defined herein.

By way of example and not limitation, other activities may define a usage event, such as the entering of a state/mode and/or operatively executing a task within the state/mode. Likewise, each attempted downloading of information and/or the number of successfully completed downloads may be deemed one event.

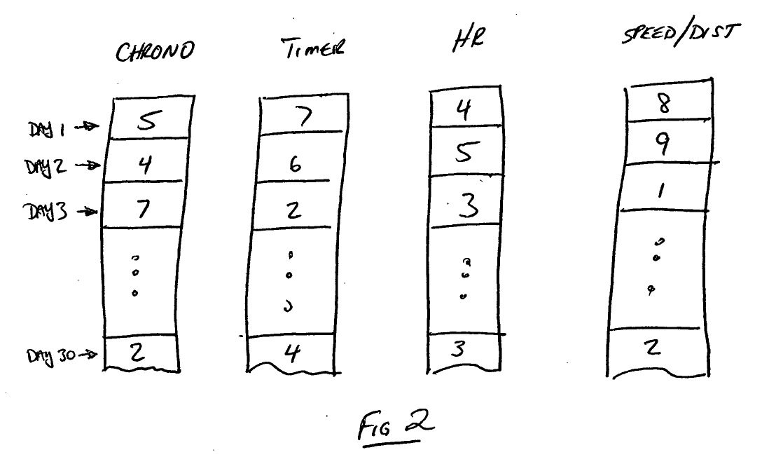

Therefore, in accordance with the present invention and as illustrated in FIG. 2, an array of counters is associated with each of the reorderable modes. In the preferred embodiment, each of the reorderable modes has associated therewith an array of 30 counters, which is by design choice and not limitation. Beginning on the “first” day, which may be designated as such by convenience, the present invention maintains a count of the number of defined usage events over a predetermined period of time for each of the reorderable modes. In the preferred embodiment, the predetermined period over which the count is maintained for all the counters in each of the arrays is thirty (30) days, thus conveniently coinciding with the number of days in a plurality of the months and/or the number of counters in the array.

An example of the methodology of the present invention is as follows:

Each day (e.g. Day 1, Day 2, Day 3, . . . Day 30), the present invention increments the number of defined usage events for each of the reorderable modes on that day. On “day 1,” the “DAY” pointer points to the respective first counter in the array for each of the reorderable modes. If for example, on “day 1,” five (5) usage events were detected for the CHRONO mode, seven (7) usage events were detected for the TIMER mode, four (4) usage events were detected for the HR mode and eight (8) usage events were detected for the SPEED/DIST mode, the counters for the respective arrays for “day 1” would appear as indicated in FIG. 1.

Preferably at midnight on day 1, the “DAY” pointer is incremented to point to the next respective counter in each array for each of the reorderable modes. Therefore, in a similar manner, if, on “day 2” four (4) usage events were detected for the CHRONO mode, six (6) usage events were detected for the TIMER mode, five (5) usage events were detected for the HR mode and nine (9) usage events were detected for the SPEED/DIST mode, the counters for the respective arrays for “day 2” would appear as indicated in each respective counter, as illustrated in FIG. 2.

Each “day” (e.g. at midnight), the “DAY” pointer is incremented so as to point to the next counter in each array for each of the reorderable modes. Thus, for completeness (and simplicity of disclosure) and in accordance with the foregoing methodology, a usage event count for “day 3” and “day 30” has been provided to FIG. 1 in order to best understand the features of the present invention.

At the conclusion of the preferred predetermined period of time (e.g. thirty (30) days), the cumulative values in the counters for each array can be determined. In the exemplary embodiment (for mere simplicity and convenience, it is assumed in this example that there was no usage events in any of the reorderable modes on days 4-29), it can be determined that the number of usage events in the array corresponding to the CHRONO mode is 18, the number of usage events in the array corresponding to the TIMER mode is 19, the number of usage events in the array corresponding to the HR mode is 15, and the number of usage events in the array corresponding to the SPEED/DIST mode is 20. Strictly on a quantitative basis, it can be seen that the most usage events (as defined) occurred in the SPEED/DIST mode, the second most usage events occurred in the TIMER mode, the third most usage events occurred in the CHRONO mode, and the least most usage events occurred in the HR mode.

Now, in accordance with an objective of the present invention, the present invention provides for the optimization of the ordering of the reorderable modes so that in the mode selecting mode, the reorderable modes are displayed in a sequence that is based on the number of defined usage events occurring (e.g. detected) in each of the reorderable modes during the previous predetermined period of time. In the present example and based on the usage events set forth in FIG. 1, at the end of the predetermined period (e.g. 30 days), the electronic device incorporating the present methodology will provide that the next time there is a cycling of the reorderable modes, the order of display will be the SPEED/DIST mode, followed by the TIMER mode, followed by the CHRONO mode and then the HR mode, keeping in mind that preceding the selectability of each reorderable mode preferably there will be a display of the respective mode indicator for that mode.

In the present exemplary embodiment, the TOD mode, having been designated as a non-reorderable mode, always remains as the default “first” mode. It can thus be seen that the present invention provides for a reordering, during a cycling therethrough in a mode selecting mode, of the display of one or more reorderable modes from a plurality of modes based on the number of defined usage events determined in each of the arrays for the previous predetermined period of time.

In another embodiment, the present invention provides for the display of the reorderable modes in a sequence that is based on the amount of time usage determined in each of the reorderable modes. In this embodiment, the “DAY” pointer is similarly incremented each predetermined period (e.g. each day) so as to maintain a count of the amount of time usage for each mode during each period. The data of FIG. 2 can thus likewise be applied to this alternate embodiment in which the entries set forth therein may represent the total number of minutes (seconds or otherwise) that the electronic device similarly was operated in that mode during the predetermined period (e.g. 24 hours).

With FIG. 2 illustrating usage in minutes, in this example FIG. 2 can be seen to illustrate that on “day 1,” the CHRONO mode was utilized for five (5) minutes, the TIMER mode was utilized for seven (7) minutes, the HR mode was utilized for four (4) minutes and the SPEED/DIST mode was utilized for eight (8) minutes. The entries for the remaining days in this example are illustrated in FIG. 2. Based on this example, a conclusion that can be drawn from FIG. 1 is that in the preceding thirty (30) days, the electronic device operated in the CHRONO mode for a total of 18 minutes, the electronic device operated in the TIMER mode for a total of 19 minutes, the electronic device operated in the HR mode for a total of 15 minutes and the electronic device operated in the SPEED/DIST mode for a total of 20 minutes.

Therefore, in another similar advantage, the present invention provides for the optimization of the ordering of the reorderable modes so that in the mode selecting mode, the reorderable modes are displayed in a sequence that is based on amount of time the device was operated in each of the reorderable modes. Therefore, in a similar way, at the end of the predetermined period (e.g. 30 days), the electronic device incorporating the present methodology will provide that the next time there is a cycling of the reorderable modes, the order of display will be the SPEED/DIST mode, followed by the TIMER mode, followed by the CHRONO mode and then the HR mode, again keeping in mind that preceding the selectability of each reorderable mode preferably will be a display of the respective mode indicator for that mode.

Preferably, the ability to and reordering of the reorderable modes occurs at the end of the predetermined period. In a preferred embodiment, the reordering of the reorderable modes may be done via actuation of a selected pusher or sequence of pushers (or selected actuation of a rotating stem). Similarly, such reordering may be automatically done by the integrated circuit that is maintaining the values in each of the counters as well as the cumulative totals of events or time in each/all of the counters in each of the arrays for each of the reorderable modes.

It can thus be seen that the present invention provides for a reordering, during a cycling therethrough in a mode-selecting mode, of the display of one or more reorderable modes from a plurality of modes based on amount of time the electronic device was operating in each of the reorderable modes.

As should be clear, the present invention provides for yet additional features useful to any user of the electronic device of the type disclosed herein. For example, if the number of defined events or amount of time falls below a defined minimum, that mode could be removed from the cycling sequence altogether, e.g. until further deliberate action is taken by the user to “reactivate” the mode. For example, if at the end of the predetermined (e.g. 30 day) period, there is less than some number of total defined events detected (or total time) in a mode, that mode may be removed from the cycle of modes (e.g. as illustrated in FIG. 1) and added to the end of the mode list. That is, at the end of the mode list (e.g. for example, as yet another mode), there is provided yet another feature whereby all the “hidden and/or disabled” modes are displayable via selection of a “MORE” (titled for convenience as such and not by limitation) feature, which permits the user to view modes that were previously disabled or otherwise removed from the primary mode list for the reasons noted above. Selection of any of the hidden and/or otherwise disabled modes by, for example, pausing on the respective mode indicator thereof or selecting via an actuation of a pusher or the like, will provide access to the hidden and/or otherwise disabled mode, such as, by example, returning the previously hidden and/or otherwise disable mode back to the primary mode list as illustrated in FIG. 1 (e.g. and placing it at the end thereof until sufficient usage events or time permits it/them to be moved “up” in the order of cycling).

To be sure, several features set forth above are by way of example and not limitation. As but only two examples, the “Day” pointer by default, increments every 24 hours. It is within the scope of the skilled artisan to change the duration to something greater than, or less than, 24 hours. Similarly, use of a 30 day predetermined period is by way of example as well, as more frequent (or less frequent) reordering of the reorderable modes is within the scope of the invention.

Still further, a defined event for one mode may be different from a similar event in another mode. For example, the mere using of the CHRONO mode (e.g. starting and stopping) may be deemed to be one event, while the setting of a date in the DATE mode (not shown) may be deemed to be one usage event, notwithstanding that more than one pusher or axial rotation was detected. Such details are left to the skilled artisan as they are not material nor outside the routine skill of the ordinary artisan. However, at the least, in the preferred embodiments, the usage events may be defined as an entering of the reorderable mode, actuation of selected actuation means while in the reorderable mode and/or an entering of the reorderable mode and remaining in that reorderable mode without exiting that mode for a predetermined minimum amount of time (e.g. 10 seconds).

One last feature of the present invention requires mentioning and is important to an appreciation of the methodology thereof. That is, after the number of detected usage events or total time for a given period of time (e.g. 24 hours) has been cumulated, the “DAY” pointer will once again return to the top of the array, thus “pointing” to the first counter in each of the respective counters in each array of a reorderable mode. Again, this will preferably occur at the expiration of the period of time (e.g. 24 hours). What also will occur at the time of moving to the next counter (regardless of position) is a resetting of the values of the respective counter for that “day.” In this way, the counters maintain an accurate and most recent account of usage events or total time for the previous days in the array.

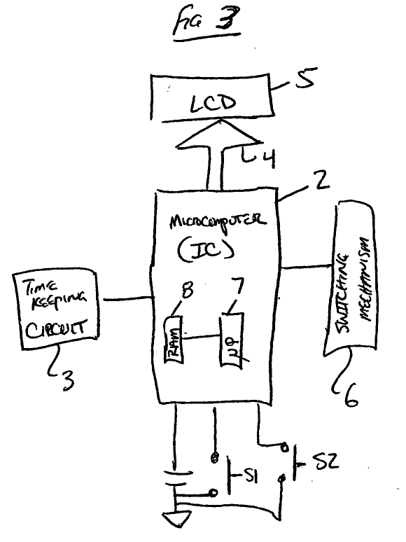

While the foregoing sets forth the methodology for carrying out the preferred embodiment of the present invention, the present invention also discloses and claims mechanical embodiments used to carry out the foregoing. FIG. 3 illustrates components of circuitry of a multimode, multifunctioning electronic timepiece 1 configured in accordance with the present invention. The circuitry is disposed within a cavity of the device's casing (not shown) and may be operable for performing, among other things, timekeeping functions. The circuitry includes a programmable microcomputer 2 in the form of an integrated circuit chip. The microcomputer 2 includes a microprocessor 7 programmed to perform instructions suitable for achieving the timekeeping functions and all the mode reordering, showing and hiding as disclosed above. The microcomputer also includes a memory device 8. The memory device 8 may store, for example, the values in the counters disclosed above in the one or more operating modes of the device. In particular, the memory device may store the electronic timepiece setting and mode selecting methodologies as software routines retrieved and executed by microprocessor 7 in accordance with the present invention. As can be appreciated, the circuitry may also include a timekeeping circuit 3, which generates time indicating signals representing, among other things, a time-of-day. Signals from the timekeeping circuit 3 as well as other signals from, for example, the switching mechanism, whether by the switching mechanism 6 which may comprise the aforementioned rotating switching mechanism or may comprise one or more pushbuttons (e.g. pushbuttons S1 and/or S2 and/or others), are processed by the microcomputer 2. The signals are passed to the microprocessor 7 for processing in accordance with the present invention, such as for example, to update the value in one or more counters based on the detection of defined usage events, such as, but one example, if such events are driven by the actuation of a pusher, a predetermined sequence of pusher actuations, or the like. An output signal via a display bus 4 is provided to a display such as, for example, a liquid crystal display 5, which exhibits the time of day and the other modes disclosed and/or contemplated herein.

Lastly, while the foregoing is a somewhat simplified circuit diagram, it is believed to be sufficient for purposes of enablement and best mode for the present invention, especially in view of the knowledge of the ordinarily skilled artisan. However, for still further details that may be applicable and useful in carrying out objectives and advantages that could be appreciated by the present invention, one may wish to review copending and coowned application Ser. No. 10/441,417 entitled “Wearable Electronic Device With Multiple Display Functionality,” the subject matter of which is also incorporated by reference as if fully set forth herein. With such disclosure, it should be appreciated that the present invention (i.e. the electronic device and the methodologies) can reorder and/or hide displayability of modes based upon a wide range of criterions, and therefore the present invention should be understood to be broadly disclosed. Accordingly, as disclosed in the cited documents herein, it is contemplated that one device, such as the electronic device of the present invention, be provided with the versatility to receive multiple sensors (e.g. HR, BP, TEMP, etc.).

It can thus be seen that the present invention provides an improved programming and mode display methodology for multimode electronic devices and, in particular, of a wristwatch, that allows the electronic device to customize itself to the use of the user. Further, by implementing the present invention, an improved mode display methodology for such electronic devices that makes the device more “user friendly” and customizable to the user is provided. Still further, the present invention provides an improved mode display methodology that makes the device more marketable to a wider range of users. Lastly (but not exhaustively), the present invention provides an improved mode display methodology that permits manufacturers, designers or programmers of such devices to further provide users with demanded functionality, yet provide a construction and methodology to permit the electronic device to configure itself to better meet the users needs, desires and uses therefor. In a specific example, the present invention provides for improved displayability of modes based on particular usage criteria of the various modes.

It will thus be seen that the objects set forth above, among those made apparent from the preceding description, are efficiently attained and, since certain changes may be made in the above constructions and methodologies without departing from the spirit and scope of the invention, it is intended that all matter contained in the above description or shown in the accompanying drawings shall be interpreted as illustrative and not in a limiting sense.

While the invention has been particularly shown and described with respect to preferred embodiments thereof, it will be understood by those skilled in the art that changes in form and details may be made therein without departing from the scope and spirit of the invention.

For example, the present invention can easily be modified to reorder and/or hide a plurality of modes if the electronic device determines that none of the modes within a group should be displayed, using the same criterions set forth above. That is, the present invention recognizes that groups of modes may be reordered and/or inhibited together, such as for example, SPORTS, HEALTH, TRAVEL, FITNESS, etc.

Lastly, the present invention has been disclosed above with particular reference to timepieces. However, one skilled in the art shall now appreciate that the present invention is equally applicable, and as claim herein, to devices other than timepieces, such as, but not limited to, clocks and security devices, such as wall mounted or handheld devices for the home or office. Therefore, reference to a device in both the disclosure and the claims should be understood to refer to at least any of the aforementioned other devices. That is, the present invention is applicable in any electronic device such as those disclosed in which particular modes and their functions can be reordered or hidden in a manner disclosed herein.

What is claimed is:

1. A method of displaying a plurality of modes in a multimode electronic device of the type having an integrated circuit operable in a plurality of modes, wherein the plurality of modes comprises a mode selecting mode and at least two reorderable modes ea ch of which has associated therewith a mode indicator, wherein in the mode selecting mode, the electronic device cycles among at least the two reorderable modes and displays mode indicators for the respective reorderable modes, such that the display of a mode indicator precedes the selectability of the reorderable mode whose mode indicator is being displayed, wherein the method of displaying the plurality of reorderable modes comprises the steps of:
determining a number of usage events over a predetermined time period for each of the at least two reorderable modes; and
in the mode selecting mode:
displaying the reorderable modes in a sequence that is based on the number of usage events determined in each of the at least two reorderable modes.

2. The method as claimed 1, wherein the predetermined period of time is 30 days.

3. The method as claimed in claim 1, including the step of maintaining a count of the number of usage events over the predetermined period of time for each of the at least two reorderable modes.

4. The method as claimed in claim 1, wherein a usage event is defined as an entering of the reorderable mode and/or actuation of selected actuation means while in the reorderable mode.

5. The method as claimed in claim 1, wherein a usage event is defined as an entering of the reorderable mode and remaining in that reorderable mode without exiting that mode for a predetermined minimum amount of time.

6. The method as claimed in claim 1, including the step of causing, by selected actuation of an actuation means, the reordering of the displayable sequence of reorderable modes.

7. The method as claimed in claim 1, including the step of removing a reorderable mode from being enterable during the cycling of the reorderable modes in the mode-selecting mode;
wherein the step of removing the reorderable mode is based on a failure to meet a minimum number of usage events over the predetermined time period.

8. The method as claimed in claim 6, wherein during the mode-selecting mode, the removed reorderable mode is unavailable for selecting.

9. The method as claimed in claim 7, comprising the steps of:
viewing the mode indicator for the reorderable mode that was removed from being enterable during the cycling of the enterable modes; and
selecting the reorderable mode that was removed from being enterable so that during a subsequent cycling of modes in the mode-selecting mode, the previously removed reorderable mode is now available for selecting.

10. A method of displaying a plurality of modes in a multimode electronic device of the type having an integrated circuit operable in a plurality of modes, wherein the plurality of modes comprises a mode selecting mode and at least two reorderable modes each of which has associated therewith a mode indicator, wherein in the mode selecting mode, the electronic device cycles among the at least two reorderable modes and displays mode indicators for each of the respective reorderable modes, such that the display of a mode indicator precedes the selectability of the reorderable mode whose mode indicator is being displayed, wherein the method of displaying the plurality of reorderable modes comprises the steps of:
determining an amount of time usage over a predetermined time period for each of the at least two reorderable modes; and
in the mode selecting mode:
displaying the reorderable modes in a sequence that is based on the amount of time usage determined in each of the at least two reorderable modes.

11. An electronic device that provides for the reorderability of at least two reorderable modes among a plurality of modes, wherein the plurality of modes comprises a mode selecting mode, and each of the at least two reorderable modes has associated therewith a mode indicator, wherein in the mode selecting mode the electronic device cycles among at least the at least two reorderable modes and displays mode indicators for each of the respective reorderable modes, such that the display of a mode indicator precedes the selectability of the reorderable mode whose mode indicator is being displayed, wherein the electronic device comprises:
a display for displaying the at least two reorderable modes and the mode indicators associated therewith; and
means for determining one or more event criterions over a predetermined time period for each of the at least two reorderable modes and for reordering the displaying of the reorderable modes during the mode selecting mode in a sequence that is based on the event criterions determined in each of the at least two reorderable modes during the predetermined period of time.

12. The electronic device as claimed in claim 11, wherein the event criterion is selected from the group of defined usage events and total time usage.

13. The electronic device as claimed in claim 11, wherein the usage event is defined as an entering of the reorderable mode and/or actuation of selected actuation means while in the reorderable mode.

14. The electronic device as claimed in claim 11, wherein a usage event is defined as an entering of the reorderable mode and remaining in that reorderable mode without exiting that mode for a predetermined minimum amount of time.
